(19) United States
(12) Patent Application Publication
(10) Pub. No.: US 2021/0308661 A1
(43) Pub. Date: Oct. 7, 2021

(54) METAL OXIDE GRAFTED COMPOSITION FOR ORGANIC DEGRADATION

(71) Applicants: MEGAN HART, KANSAS CITY, MO (US); SHELDON COOK, KANSAS CITY, MO (US); HANNAH McINTYRE, KANSAS CITY, MO (US)

(72) Inventors: MEGAN HART, KANSAS CITY, MO (US); SHELDON COOK, KANSAS CITY, MO (US); HANNAH McINTYRE, KANSAS CITY, MO (US)

(21) Appl. No.: 17/221,144

(22) Filed: Apr. 2, 2021

Related U.S. Application Data
(60) Provisional application No. 63/004,007, filed on Apr. 2, 2020.

(51) Int. Cl. B01J 35/00; C07F 7/28; B01J 31/22; B01J 21/08; B01J 31/16; B01J 37/08; B01J 37/02; B01J 35/08; B01J 35/06; C02F 1/32; C02F 1/72

(52) U.S. Cl. CPC B01J 35/004; C07F 7/28; B01J 31/2208; B01J 21/08; B01J 31/1658; B01J 37/08; C02F 2101/34; B01J 35/08; B01J 35/06; C02F 1/32; C02F 1/725; B01J 2531/46; C02F 2305/10; B01J 37/0203

(57) ABSTRACT

Disclosed are compositions for degrading organic compounds, the composition comprising a support comprising one or more of a polyolefin and a compound comprising silicon and an acid anhydride of the structure:

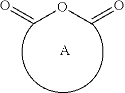

grafted to the polyolefin and/or the compound comprising silicon; and one or more metal oxides bound with the acid anhydride; wherein A is a cycloalkyl, heterocycloalkyl, or fused ring system comprising at least one unconjugated -ene group. Also disclosed are processes for making the composition, and methods for degrading organic compounds in a fluid.

### CROSS-REFERENCE TO RELATED APPLICATIONS

This application claims the benefit to U.S. Provisional Application Ser. No. 63/004,007, filed Apr. 2, 2020, which is incorporated herein by reference in its entirety.

### BACKGROUND OF THE DISCLOSURE

The present disclosure relates generally to metal oxide grafted catalytic compositions for degradation of organic compounds, such as pollutants.

Organic contaminants are some of the most concerning pollutants in water systems. Many pose potential harm to human health and the environment despite implementation of water management practices. There are many sub categories of organic contaminants with varying concerns and remediation strategies. Some total petroleum hydrocarbons (TPH) compounds such as benzene are highly carcinogenic, while others such as gasoline are listed by the International Agency for Research on Cancer (IARC) as known carcinogens when occupationally encountered during routine use. Hydrocarbons from petroleum are a large contributor to urban pollutant load and are generally more concentrated in heavily trafficked areas. In agricultural areas, concerning concentrations of organic pesticides have been found. Pharmaceuticals and personal care products are pollutants that have begun to emerge in urban runoffs. Synthetic dyes can cause numerous health effects such as respiratory sensitization, skin irritation, and asthma. Since the industrial switch from natural dyes to synthetic, over 100,000 synthetic dyes have been produced and have been widely associated with water pollution due to the 10-15% waste during production. Other, specific organic contaminants include polychlorinated biphenyls (PCBs), polycyclic aromatic hydrocarbons (PAHs), organochlorine pesticides (OCPs), and per- and polyfluoroalkyl substances (PFAS). Considering the vast impact organic contaminants have, a method is needed to mitigate the contaminants in water.

A particularly concerning class of organic contaminants is per- and polyfluoroalkyl substances (PFAS). Example PFAS include perfluorooctanoic acid (PFOA) and perfluorooctanesulfonic acid (PFOS), which are associated with human liver, immunological, developmental, endocrine, reproductive, and cardiovascular issues, along with potential for causing cancer. PFAS are synthetic organofluorine chemical compounds that have multiple fluorine atoms attached to an alkyl chain. PFAS are characterized by a carbon-fluorine (C—F) backbone and contain at least one perfluoroalkyl moiety, —CₙF₂ₙ—. C—F bonds are one of the strongest bonds in organic chemistry (116 kcal/mol), which gives these chemicals long term stability and persistence in the environment. In addition. PFAS tend to form stable complexes with polar and non-polar soil or organics in the subsurface. For these reasons. PFAS have been dubbed “Forever Chemicals.” In 2009. PFAS were listed as persistent organic pollutants under the Stockholm Convention due to their ubiquitous, persistent, bioaccumulative, and toxic to humans. PFAS waste is extremely resistant to degradation, both natural and biological. PFAS elude most conventional treatment methods such as advanced oxidation processes (AOP) or membrane treatment techniques. As a result, these substances are often incinerated for permanent disposal. There is growing concern that incineration simply transforms the PFAS waste product from one phase to another, which will in turn require installation in a landfill.

Photocatalysts are substances that use absorbed light to produce photoexcited electrons. These photoexcited electrons are then transferred from the valence band gap to the conduction band gap. This process generates electron-hole pairs (e−/h+) which act to reduce and/or oxidize organic compounds and decompose water adjacent to the catalyst surfaces. Heterogenous metal oxides such as TiO₂, ZnO, SnO₂, and CeO₂ are naturally occurring, abundant, and widely used in photocatalytic applications because of their ability to produce positive electrons holes. Organic contaminants degrade in the presence of photocatalytic metals such as titanium or bismuth; however, grafting the metals to a substrate that will not absorb or adhere the organic contaminant itself is problematic. Most methods include sintering of non-organic materials such as activated carbon or nitrogenated complexes to form a reusable reactive composition that will not also absorb the organic material and therefore prevent degradation of the organic contaminant. These composition preparation methods are costly and time intensive.

These shortcomings highlight the need to develop new compositions for degradation of organic compounds like PFAS.

### BRIEF DESCRIPTION OF THE DISCLOSURE

The present disclosure relates generally to compositions for degrading organic compounds, wherein the compositions include a metal oxide affixed to a support via an acid anhydride bridge.

In one aspect, the present disclosure is directed to a composition for degrading organic compounds, the composition comprising
a support comprising one or more of a polyolefin and a compound comprising silicon;
an acid anhydride of the structure:

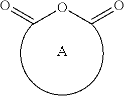

grafted to the polyolefin and/or the compound comprising silicon; and
one or more metal oxides bound with the acid anhydride;
wherein A is a cycloalkyl, heterocycloalkyl, or fused ring system comprising at least one unconjugated -ene group.

Another aspect of the present disclosure is directed to a method for degrading one or more organic compounds in a fluid comprising:
adding into the fluid a composition for degrading organic compounds comprising:
   a support comprising one or more of a polyolefin and a compound comprising silicon;
   an acid anhydride of the structure:

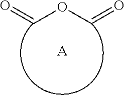

grafted to the polyolefin and/or the compound comprising silicon; and
one or more metal oxides bound with the acid anhydride:
wherein A is a cycloalkyl, heterocycloalkyl, or fused ring system comprising at least one unconjugated -ene group; and
irradiating the composition for degrading organic compounds with electromagnetic radiation.

Another aspect of the present disclosure is directed to a process for preparing a composition for degrading organic compounds, the process comprising:
heating one or more of a polyolefin and a compound comprising silicon with an acid anhydride of the structure:

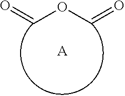

wherein A is a cycloalkyl, heterocycloalkyl, or fused ring system comprising at least one unconjugated -ene group:
forming a support comprising the polyolefin and/or the compound comprising silicon; and
binding the acid anhydride to one or more metal oxides.

### BRIEF DESCRIPTION OF THE DRAWINGS

The disclosure will be better understood, and features, aspects and advantages other than those set forth above will become apparent when consideration is given to the following detailed description thereof. Such detailed description makes reference to the following drawings, wherein:

FIG. 1 depicts FTIR spectra of maleic anhydride (MAH) and of titanium (Ti) bonded with MAH (Ti-MAH).

FIG. 2 depicts an XRD diffractogram of titanium dioxide.

FIG. 3 depicts an XRD diffractogram of Ti-MAH Powder

FIG. 4 depicts FTIR spectra of Ti-MAH and of Ti-MAH bonded to silicon (Ti-MAH-Si).

FIG. 5 depicts a zoom on in the C—H stretch region in the spectra of FIG. 4.

FIG. 6 depicts XPS elemental mapping of titanium in fumed silica particles.

FIG. 7 depicts XPS elemental mapping of silica in the fumed silica particles of FIG. 6.

FIG. 8 depicts an SEM backscatter image of the fumed silica particles of FIGS. 6 and 7 overlaid with the XPS elemental mapping of titanium and silica in FIGS. 6 and 7.

FIG. 9 depicts a scanning electron microscopy image of a polypropylene bead with grafted titanium.

FIG. 10 depicts the results of an experiment measuring methylene removal at various initial concentrations using the bead of FIG. 9.

FIG. 11 depicts a water treatment device.

FIG. 12 depicts perfluorooctanesulfonic acid (PFOS) effluent concentration over time relative to PFOS influent concentration for water treated with the device of FIG. 11.

FIG. 13 depicts fluoride concentrations over time at the output flow and mid-point of the water treatment device of FIG. 11.

FIG. 14 depicts shows sulfate concentration over time at the output flow and mid-point of the water treatment device of FIG. 11.

FIG. 15 depicts SEM images of fluorite crystals and PFOS polymers in water treated for less than 15 minutes in the water treatment device of FIG. 11.

FIG. 16 depicts SEM images of fluorite crystals and PFOS polymers in water treated for about 15 minutes in the water treatment device of FIG. 11.

While the disclosure is susceptible to various modifications and alternative forms, specific embodiments thereof have been shown by way of example in the drawings and are herein described below in detail. It should be understood, however, that the description of specific embodiments is not intended to limit the disclosure to cover all modifications, equivalents and alternatives falling within the spirit and scope of the disclosure as defined by the appended claims.

### DETAILED DESCRIPTION OF THE DISCLOSURE

Unless defined otherwise, all technical and scientific terms used herein have the same meaning as commonly understood by one of ordinary skill in the art to which the disclosure belongs. Although any methods and materials similar to or equivalent to those described herein can be used in the practice or testing of the present disclosure, certain exemplary methods and materials are described below.

The approach of the present disclosure is to affix a metal oxide to a support via an acid anhydride bridge. The resulting composition may be used for degrading organic compounds. For example, in some embodiments a support (e.g. a bead including silica or polypropylene) is affixed to photocatalytic titanium using maleic anhydride as a bridge, and the resulting composition may be irradiated (e.g. with UV light) to induce degradation of the organic compounds.

In one aspect, the present disclosure is directed to a composition for degrading organic compounds, the composition comprising a support comprising one or more of a polyolefin and a compound comprising silicon and an acid anhydride of the structure:

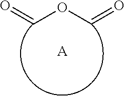

grafted to the polyolefin and/or the compound comprising silicon; and one or more metal oxides bound with the acid anhydride; wherein A is a cycloalkyl, heterocycloalkyl, or fused ring system comprising at least one unconjugated -ene group.

The composition includes a support on which active components of the composition are deposited. The support can be in any suitable shape. A suitable support is a filament. Particularly suitable filaments have a width of about 1 nanometer to about 2 inches. In certain embodiments, the filament has a width of less than about 2 inches. In some embodiments, the filament is a 3D printed filament. In certain embodiments, the support is a bead. Particularly suitable beads have a diameter of about 1 nanometer to about 2 inches. In certain embodiments, the bead has a diameter of less than about 2 inches.

The support includes one or more materials to which the acid anhydride can be grafted. In some embodiments, the support comprises polyolefin. Particularly suitable polyolefins include polyethylene and polypropylene. In certain embodiments, the polyolefin is low density polyethylene.

In some embodiments, the support comprises a compound comprising silicon. In some embodiments, the compound comprising silicon comprises at least one silicon atom. In some embodiments, the compound comprising silicon comprises a silane and/or a siloxane. Silanes refers to many compounds with four substituents on silicon, including organosilicon compounds. Examples include trichlorosilane (SiHCl₃), tetramethylsilane (Si(CH₃)₄), tetraethoxysilane (Si(OC₂H₅)₄), and binary silicon-hydrogen compounds with the empirical formula SiₓH_{y}. Siloxanes refers to compounds with an Si—O—Si linkage. Siloxanes include oligomeric and polymeric hydrides with the formulae H(OSiH₂)ₙOH and (OSiH₂)ₙ. Siloxanes also include branched compounds, the defining feature of which is that each pair of silicon centers is separated by one oxygen atom. In some embodiments, the compound comprising silicon is silica. In some embodiments, the compound comprising silicon is a derivative of silica. For example, suitable supports are provided by concrete/cement comprising silica, or the compound comprising silicon may be provided by silica-containing paints, coatings and adhesives, construction building materials, plastic modifiers, glass materials, optics and LEDs, and silica-containing materials.

In some embodiments, the support has an outer surface and the acid anhydride is grafted to the polyolefin and/or the compound comprising silicon at about the outer surface of the support. In some embodiments, the support has an outer surface and the one or more metal oxides bind with the acid anhydride at about the outer surface of the support. In some embodiments, the one or more metal oxides are bound to the acid anhydride grafted to the polyolefin and/or compound comprising silicon and dispersed within the support.

The composition comprises an acid anhydride grafted to the support. Suitable acid anhydrides are of the structure:

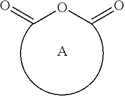

wherein A is a cycloalkyl, heterocycloalkyl, or fused ring system comprising at least one unconjugated -ene group. In some embodiments, A is a cycloalkyl or fused ring system that comprises 4-10 carbons. For example, a particularly suitable acid anhydride is tetrahydrophthalic anhydride. Another particularly suitable acid anhydride is maleic anhydride.

As used herein, “grafted” means temporarily or permanently attached by physical or chemical means. For example, in some embodiments the acid anhydride is dispersed into a composition comprising the polyolefin and/or the compound comprising silicon and formed into the support. In certain embodiments, the acid anhydride is grafted to polyolefin and/or the compound comprising silicon via a chemical bond. For example, in some embodiments the acid anhydride binds with the polyolefin and/or the compound comprising silicon. In certain embodiments, the bond is irreversible. In certain embodiments, the bond is at the -ene group of the acid anhydride. For example, in some embodiments, a maleic anhydride irreversibly binds a polyolefin at the -ene group.

The composition also includes one or more metal oxides that bind with the acid anhydride and provide photocatalytic capabilities to the composition. Photocatalysts are materials capable of producing photoexcited electrons by absorbing light. Photoexcited electrons may then elevate from the valence band gap to the conduction band gap and generate electron-hole pairs (e−/h+) that produce transformation of reaction participants. The resulting pair (e−/h+) act to reduce and/or oxidize compounds adjacent to the reactant surfaces making this method of contaminant treatment particularly effective for organic contaminants. TiO₂, ZnO, SnO₂, and CeO₂ are heterogeneous photocatalysts that are abundant in nature and utilized in semi-conductor applications. Heterogenous metal oxides are used in photocatalytic applications because of the ability to produce positive electron holes in the presence of UV light under ambient conditions. Band gap is a measure of energy needed to promote an electron from the valence band to the conduction band and is generally considered a measure of reactivity of the photocatalyst. The higher the band gap the more energy garnered during photoexcitation.

Following absorption of electromagnetic radiation, a photocatalyst is able to use the energy of the radiation to enable chemical reactions through various mechanisms. In some embodiments, the photocatalyst is capable of generating aqueous electrons following irradiation. In some embodiments, the photocatalyst is capable of generating singlet oxygen following irradiation. In some embodiments, the photocatalyst is capable of generating reactive oxygen species following irradiation. In certain preferred embodiments, the photocatalyst is capable of degrading organic compounds following irradiation.

In certain embodiments, the one or more metal oxides bind irreversibly with the acid anhydride. For example, in some embodiments, a maleic anhydride binds titanium oxide. Without being bound by particular theory, it is believed that grafting the acid anhydride to the metal oxide results in ring opening of the acid anhydride. For example, it is believed maleic anhydride binds with titanium in a ring opening reaction to form the structure:

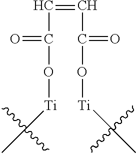

Also for example, it is believed that a preceding or subsequent reaction with a support including silica ultimately forms the structure:

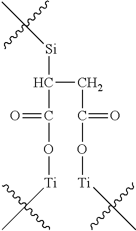

The variable attachments to the silicon and titanium(s) atoms may represent single, double, or triple covalent bonds or metallic bonds to one or more atoms as appropriate to satisfy bonding and valency properties. For example, in some embodiments the variable bond to silicon is two single bonds to hydrogen atoms and a single bond attaching the silicon to the remainder of the support. In some embodiments, the variable bond to silicon is two single bonds to methyl groups and a single bond attached the silicon to the remainder of the support. In some embodiments, the single bond attaching the silicon to the remainder of the support is a single bond to oxygen.

In some embodiments, the acid anhydride is maleic anhydride, the support comprises a compound comprising silicon, and the composition comprises the structure

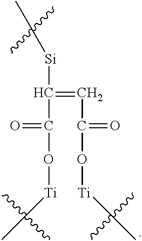

When used herein, the structure:

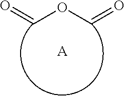

comprises the open ring form of the acid anhydride after grafting to the metal oxide.

In some embodiments, the acid anhydride is grafted to the support before binding to the metal oxide. In some embodiments, the acid anhydride is bound to the metal oxide before grafting to the support. In some embodiments, the acid anhydride is grafted to the support simultaneously with binding to the metal oxide.

Suitable metal oxides include titanium, bismuth, or a combination thereof. Particularly suitable metal oxides include TiO, TiO₂, Ti₂O₃, Ti₃O, Ti₃O, Ti₄O₇, Ti₅O₉, TiₙO₂ₙ₋₁ where n ranges from 3 to 10, BiOCOOH, Bi₂WO₆, (BiO)₂CO₃, BiVO₄, BiPO₄, Bi₂O₃, BiOCl, or combinations thereof. In certain preferred embodiments, the metal oxides include TiO₂, Ti₄O₇, TisO₉, BiOCOOH, (BiO)₂CO₃, BiPO₄, or combinations thereof.

In some embodiments, the one or more metal oxides comprise from about 1% to about 60% TiO₂ or BiOCOOH, from about 1% to about 70% Ti₄O₇ or BiO₂CO₄, and about 1% to about 60% TisO₉ or BiPO₄ by mass percent. Particularly suitable metal oxides comprise about 30% TiO₂, about 40% Ti₆O₇, and about 30% Ti₅O₉ by mass percent.

The metal oxides may be of a mineral form. In some embodiments, the one or more metal oxides comprise a mineral form of TiO₂, Ti₄O₇, TisO₉, BiOCOOH, (BiO)₂CO₃, BiPO₄ or combinations thereof.

As stated, the metal oxide in the composition confers photocatalytic capabilities to the composition. The photocatalytic capabilities of the metal oxide may be native to the metal, or may be enabled or enhanced by the arrangement (e.g. crystallographic configuration) of the metal in the composition. In some embodiments, the metal oxide is naturally a photocatalyst. In some embodiments, the metal oxide is in a crystallographic configuration. In certain preferred embodiments, the crystallographic configuration has a 110 or 011 face presentation.

Particularly suitable crystallographic configurations of the metal oxide provide for preferable fermi levels. In some embodiments, the photocatalyst in the crystallographic configuration has a fermi level of about 0.01 eV to about 1 eV higher than the one or more metal oxides alone. Preferably, the photocatalyst in the crystallographic configuration has a fermi level of about 0.1 eV higher than the one or more metal oxides alone. A suitable photocatalyst in the crystallographic configuration has a fermi level of about 2.6 eV to about 3.9 eV. In certain embodiments, the photocatalyst in the crystallographic configuration has a fermi level of about 2.9 eV.

A photocatalyst is capable of absorbing electromagnetic radiation. Particularly suitable photocatalysts are capable of absorbing ultraviolet radiation. Preferably, the photocatalyst is capable of absorbing electromagnetic radiation of from about 250 nm to about 500 nm. More preferably, the photocatalyst is capable of absorbing electromagnetic radiation of about 256 nm.

In certain embodiments, the support is in the form of a tube or sleeve, for example the tube or sleeve described in Example 10. The tube or sleeve defines an interior space that may house an activation energy source, such as a UV lamp. The interior may packed with granular material METHODS

Another aspect of the present disclosure is directed to a method for degrading organic compounds, wherein the method includes introducing a composition for degrading organic compounds, including any of the compositions described herein, into or adjacent to a fluid comprising the organic compound and irradiating the composition with electromagnetic radiation.

In particularly suitable methods, the irradiating step includes irradiating with ultraviolet radiation. In certain embodiments, the electromagnetic radiation of the irradiating step is from about 10 nm to about 400 nm. For example, the electromagnetic radiation of the irradiating step may be about 256 nm.

In particularly suitable methods, the irradiating step is completed in about 30 seconds to about 30 minutes. In certain preferred embodiments, the irradiating step is completed in less than about 5 minutes.

In some embodiments, the irradiating step causes the composition to generate aqueous electrons, singlet oxygen, reactive oxygen species, or combinations thereof that react with and degrade the organic compounds. In some embodiments, the irradiating step causes the composition to generate aqueous electrons. In some embodiments, the irradiating step causes the composition to generate singlet oxygen. In some embodiments, the irradiating step causes the composition to generate reactive oxygen species.

In some embodiments, the irradiating step causes the composition to undergo intersystem crossing with the organic compound to degrade the organic compound.

In some embodiments, the method is conducted under a non-reactive gas, such as nitrogen.

In some embodiments, the method is conducted using a tube.

In some embodiments, the organic compound does not absorb to the composition.

The composition for degrading organic compounds may be used on a variety of organic compounds of industrial, health, or environmental interest. For example, in some embodiments the organic compound is a pharmaceutical. In some embodiments, the organic compound is an organic based contaminant. In some embodiments, the organic compound comprises hexane and/or benzene rings. In some embodiments, the organic compound is a non-aqueous phase liquid, an oil, or grease. In some embodiments, the organic compound is xylene, toluene, a light volatile organic carbon, or a surfactant. In some embodiments, the organic compound is a pesticide or an herbicide (e.g. glyphosate). In certain embodiments, the organic compound is a perfluorinated compound. A particularly suitable organic compound is a perfluoroalkyl substance or polyfluoroalkyl substance. For example, in some embodiments the organic compound is perfluorooctanoic acid or polyfluorooctanoic acid. In some embodiments, the organic compound is polyfluorooctanesulfonic acid.

Suitable organic compounds to be treated are in wastewater, landfill leachate, groundwater, wash water, drinking water, lakes, rivers, streams, bays, and/or estuaries.

In another aspect, the composition for degrading organic compounds is used in air purification (e.g. as a smoke stack scrubber).

### Processes for Making

Further aspects of the present disclosure are directed to processes for preparing a composition for degrading organic compounds, including any of the compositions described herein, from an acid anhydride, a metal oxide, and one or more of a polyolefin and a compound comprising silicon. In some embodiments, the acid anhydride is grafted to the polyolefin and/or the compound comprising silicon before binding to the metal oxide. In some embodiments, the acid anhydride is bound to the metal oxide before grafting to the polyolefin and/or the compound comprising silicon. In some embodiments, the acid anhydride is grafted to the polyolefin and/or the compound comprising silicon simultaneously with binding to the metal oxide.

An aspect of the present disclosure is directed to a process for preparing a composition for degrading organic compounds, the process comprising:
heating one or more of a polyolefin and a compound comprising silicon with an acid anhydride of the structure:

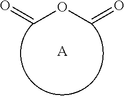

wherein A is a cycloalkyl, heterocycloalkyl, or fused ring system comprising at least one unconjugated -ene group;
forming a support comprising the polyolefin and/or the compound comprising silicon; and
binding the acid anhydride to one or more metal oxides.

In some embodiments, the acid anhydride is bound to the metal oxide before heating the polyolefin and/or the compound comprising silicon with the acid anhydride.

In some embodiments, the process comprises heating polyolefin and the polyolefin is polyethylene or polypropylene. In some embodiments, the process comprises heating the compound comprising silicon.

In some embodiments, the polyolefin and/or the compound comprising silicon is heated to just below its melting point. In certain embodiments, the polyolefin and/or the compound comprising silicon is heated to from about 60° C. to about 200° C., or from about 60° C. to about 100° C. For example, the polyolefin and/or the compound comprising silicon may be heated to about 150° C.

In some embodiments, the polyolefin and/or the compound comprising silicon is heated for between 3 hours to about 24 hours. In certain embodiments, the polyolefin and/or the compound comprising silicon is heated for less than about 6 hours. For example, the polyolefin and/or the compound comprising silicon may be heated for about 4 hours.

In some embodiments, reacting the acid anhydride with the one or more metal oxides is conducted at less than about 140° C. In certain embodiments, reacting the support with the one or more metal oxides is conducted at from about 90° C. to about 140° C.

In some embodiments, reacting the acid anhydride with the one or more metal oxides is conducted in about 2 hours to about 24 hours.

In some embodiments, the one or more metal oxides is dissolved in solvent for reacting with the acid anhydride. In certain embodiments, the one or more metal oxides is dissolved in a solvent comprising ether, ethylene, or methanol. In some such embodiments, the solvent is methanol.

In some embodiments, the support is extruded and shaped. In certain embodiments, the resulting shape is a sleeve, a microfilter, a strainer, a sieve, a cage, a filament, a sheet, or a bead. In certain preferred embodiments, the support is shaped into a bead.

Another aspect of the present disclosure is directed to a composition for degrading organic compounds prepared by the processes described herein.

### EXAMPLES

Non-limiting Examples 1-6 demonstrate binding of an example metal oxide to an example acid anhydride and grafting of the metal oxide and the acid anhydride to a support.

### Example 1

This example presents binding of an example metal oxide with an example acid anhydride.

Titanium (IV) oxide, Aeroxide® P25, ACROS Organics was purchased from Thermo Fisher Scientific. XRD analysis of the P25 indicated the TiO₂ was composed of primarily anatase and some rutile, with anatase presenting more intense peaks. Maleic anhydride (99% purity, Lot #MKCJ0038) was purchased from Sigma Aldrich Company and ACS reagent grade methanol (99.8% purity) was purchased from thermo Fisher Scientific.

Titanium dioxide was reacted with maleic anhydride at ratios of three to one (3Ti-MAH) and two to one (2Ti-MAH). These ratios were based upon theoretical reactive bonding sites available in the Ti-MAH group, reactive sites of the functionalized material available in order for the group to bind, and the minimal amount of titanium required. TiO₂ and MAH were dissolved in together methanol and heated until the solution temperature equilibrated to 65° C. The solution was maintained at a constant temperature for 4 hours and continuously stirred in order to allow for complete functionalization to occur. The solution was then placed in an oven at 35° C. to dry (or alternatively dried in ambient conditions) until only powder remained. The resultant powder was ground by mortar and pestle to an equivalent particle gradation.

### Example 2

This example presents FTIR validation of binding of the metal oxide to the acid anhydride.

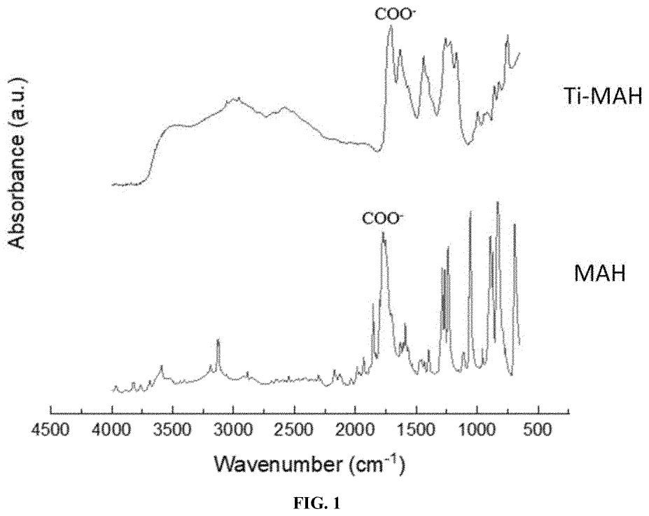

Binding of the TiO₂ to MAH was validated using Fourier-transform infrared spectroscopy (FTIR). Ti-MAH composites were prepared at a 1:1 ratio for all analysis. FTIR measurements show a shift and broadening of the carboxylate peaks in the MAH, verifying binding (FIG. 1). It was believed based on spectra analysis that the major structure arrangement was two C—O—Ti arranged in an open monodentate configuration:

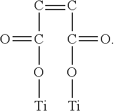

FTIR analysis verified that 2Ti-MAH showed benefits over 3Ti-MAH. The photocatalytic testing discussed later corroborated enhanced reactivity when a 2:1 ratio material was used compared to a 3:1 ratio, though both ratios were more reactive than TiO₂.

### Example 3

This example presents XRD validation of binding of the metal oxide to the acid anhydride.

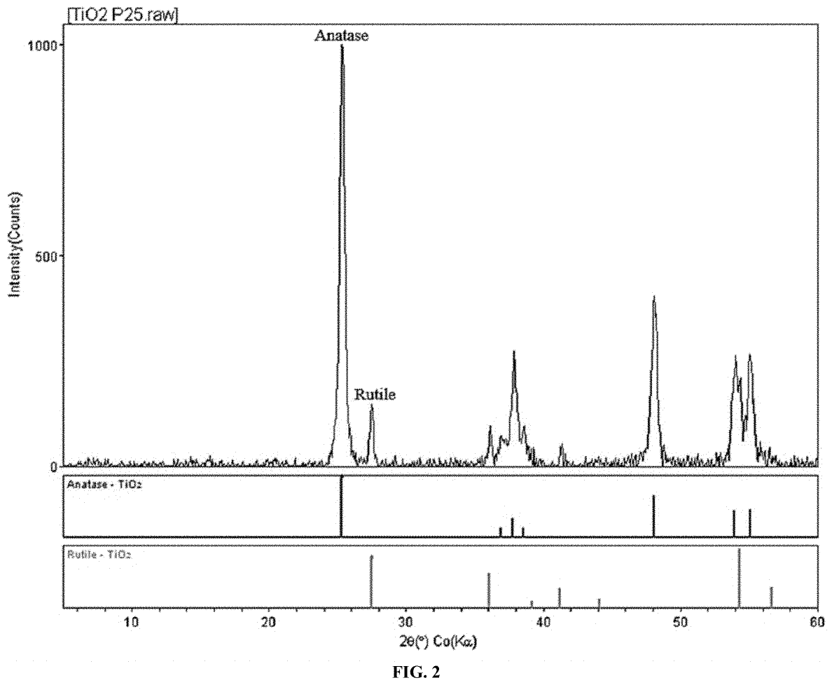

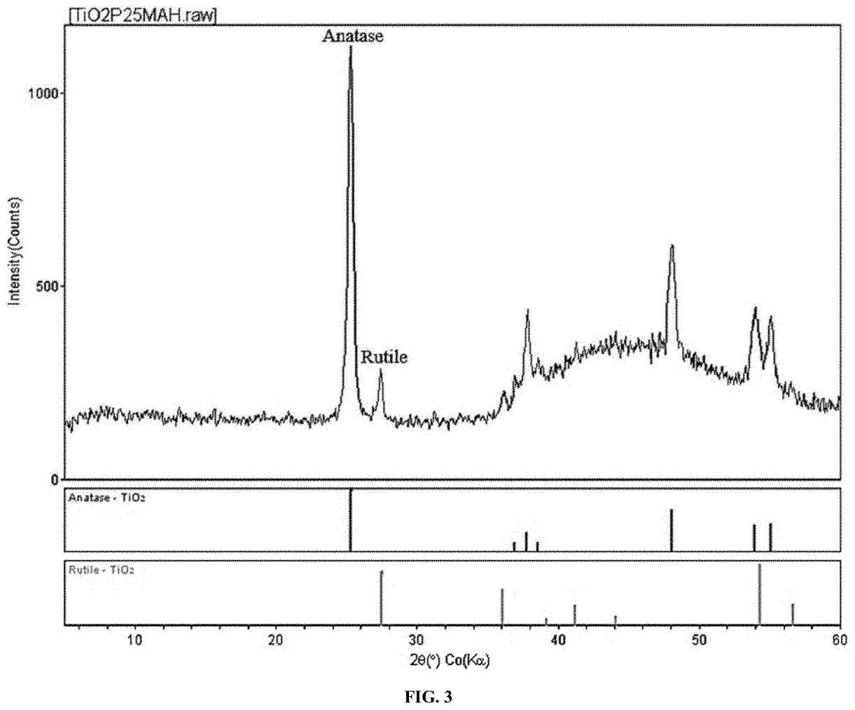

Functionalization of the TiO₂ to MAH was also validated using x-ray diffraction (XRD). XRD identified both anatase and rutile peaks, with anatase peak intensity more abundant (FIG. 2). After the TiO₂ was functionalized to the MAH an amorphous structure was detected during XRD analysis starting at about 38° and ending at 58° 2 theta angles (FIG. 3). Therefore, indirect evidence of functionalization was present.

### Example 4

This example presents grafting of an example support comprising silica to the bonded metal oxide and acid anhydride.

Different forms of amorphous surrogate silica were used to simulate bonding of the various silica phases, as well as the point of bonding. Silica was added to methanol at a 1:1 ratio of silica to Ti-MAH. Solutions were continuously stirred for 4 hours after equilibration to promote bonding (Ti-MAH-Si). The resultant solution was heated at 65° C. and continuously stirred for 12 hours. The Ti-MAH-Si was dried at 35° C. for 24 hours and the dried residuals ground to an equivalent gradation using mortar and pestle. FT-IR. XRD, and SEM/EDS analysis was performed on powder from the same batch.

### Example 5

This example presents FTIR validation of grafting of the support to the bonded metal oxide and acid anhydride.

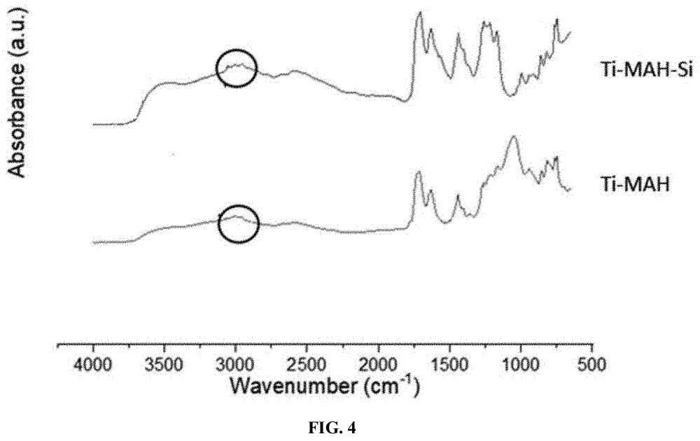

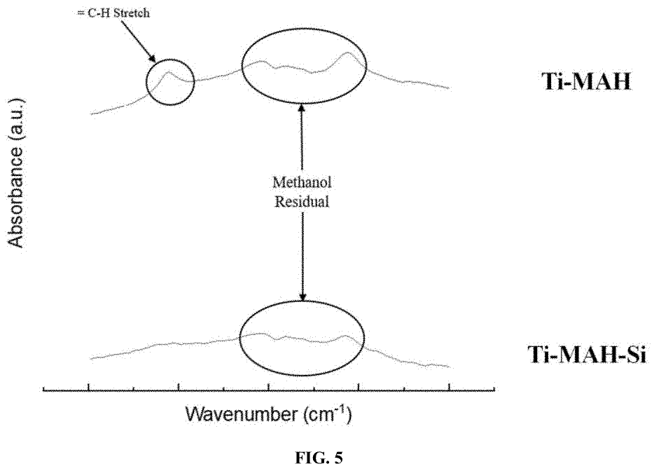

FTIR was performed on Ti-MAH-Si and compared to the Ti-MAH FTIR spectra to determine bonding points to MAH (FIG. 4). The spectra demonstrated vibration changes after silica addition. The Ti-MAH-Si spectra showed MAH carboxylates peaks were still present, and showed a shift and broadening of those peaks. The Ti-MAH-Si spectra also showed additional peaks below 1500 cm⁻¹, which were justified considering the silica addition. The primary peak of interest was the C—H stretch peak. FIG. 5 shows a ═C—H stretch peak in the Ti-MAH FTIR spectra. This peak was absent in the Ti-MAH-Si spectra. This peak disappearance verified breakage of the double bond to accommodate formation of a bond between silicon and Ti-MAH.

### Example 6

This example presents SEM and EDS validation of grafting of the support to the bonded metal oxide and acid anhydride.

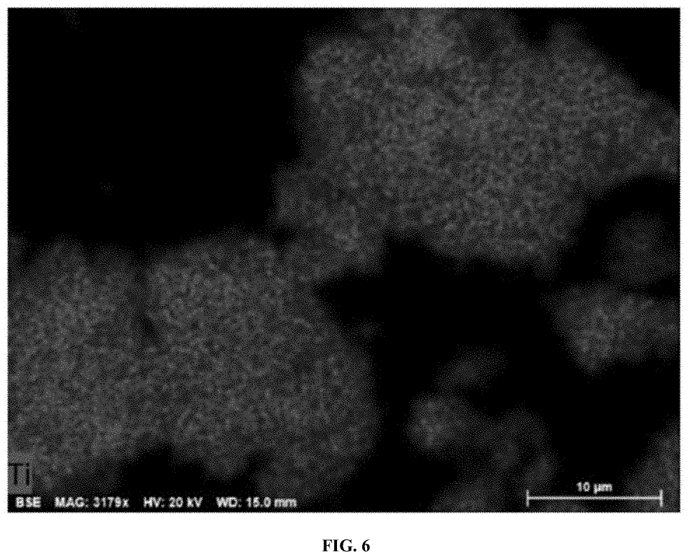

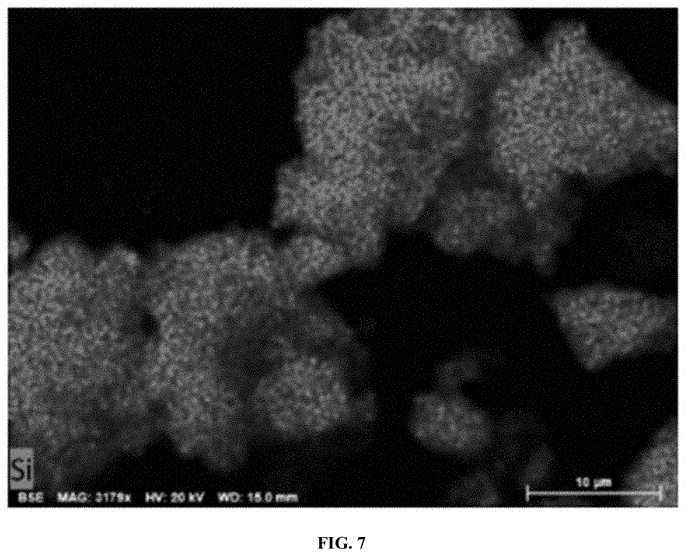

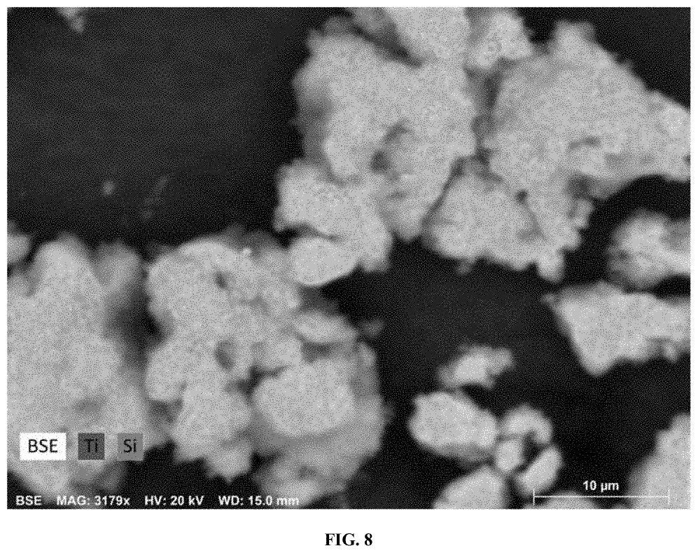

Powders prepared for FTIR were also used for scanning electron microscopy (SEM) analysis and for elemental mapping with energy dispersive x-ray (EDS). FIGS. 6-8 show elemental mapping of fumed silica particles bonded with Ti-MAH. FIG. 6 shows elemental mapping of titanium, and FIG. 7 shows elemental mapping of silicon. FIG. 8 shows FIGS. 6 and 7 overlaid on an SEM image in backscatter electron mode. Titanium was always present where silicon was present. The Ti-MAH within the beam focus exhibited extensive coating on the fumed silica particles, showing evidence of bonding to silica. From these images, it was determined that titanium evenly coated the silica particles.

### Example 7

This example presents grafting of an example acid anhydride to an example support (a polypropylene bead) followed by bonding to an example metal oxide, with subsequent characterization.

A photocatalytic composition was developed that included an acid anhydride grafted into a plastic support (a polypropylene bead or filament). Insertion of the acid anhydride occurred through temperature or pressure processes when the plastic was heated to just below or at its melting point. Once the anhydride portion of the graft was inserted into the structure of the plastic, the graft was then bonded irreversibly to metal oxides (titanium, bismuth, and/or their oxides) under specific process conditions.

For example, polypropylene plastic was heated with free maleic anhydride to 150° C. for 4 hours during which the materials were stirred together to encourage dispersion. Individual beads were then cut. The ratios used were based upon mass percent of the photocatalyst. The plastic was then placed in a reactor vessel with free metal oxides (TiO₂ as anatase, reagent grade) dissolved in pure methanol and heated to 90° C. for a period of 2 to 24 hours. This process coated a thin layer of titanium dioxide over the surface of the plastic where the graft irreversibly bonded to free titanium dioxide. Over time, the metal oxide coated the surface of the plastic in a specific crystallographic configuration of 110 or 011 face presentation. Once the graft process was completed, the composition was rinsed in deionized water to remove and recover excess or loose titanium dioxide, dried in an oven at low temperature, and then stored for usage. It was found that grafting the anatase in the 110 crystal configuration gave an enhanced fermi gap with an electron potential energy of 2.9 eV, 0.1 eV higher than titanium dioxide alone.

Examples 8 and 9 demonstrate production of example photocatalytic beads and their use for degradation of an example organic compound.

### Example 8

This example presents grafting of another example support (polypropylene beads) to bonded metal oxide and acid anhydride.

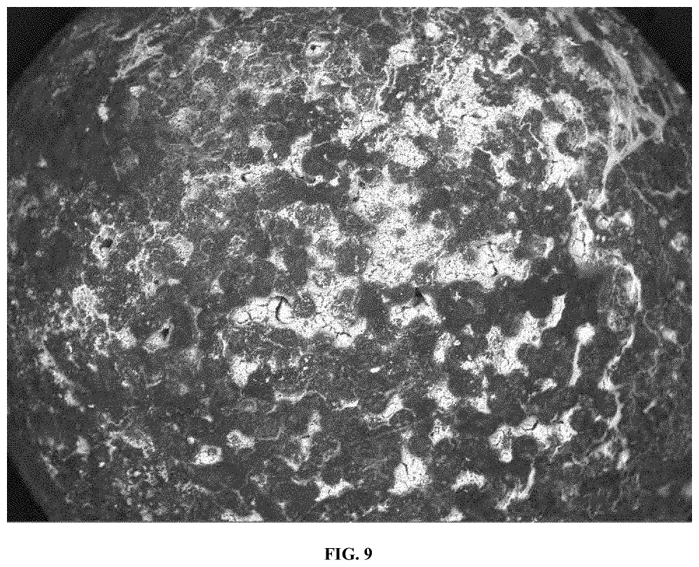

Polypropylene beads (PP beads) with a 10-15% graft of maleic anhydride were utilized in this study. To ensure titanium was immoblized onto every graft site a 10:2 ratio of PP beads to titanium dioxide (TiO₂) was utilized. PP beads, titanium dioxide, and methonal (as a solvent) were added to a glass beaker. The mixture was then stirred and heated for 4-8 hours at 200 rpm and 95° C. Once the titanium was immoblized onto the PP beads the PP beads were rinsed throughly in methonal and then de-ionized water. The PP beads were then dried in a oven at 40° C. The PP bead was imaged using a scanning electron microscope in back scattered electron mode. Results are shown in FIG. 9, which shows the distribution of titanium (white) on the PP bead (black).

### Example 9

This example demonstrates degradation of an example organic compound by the photocatalytic beads.

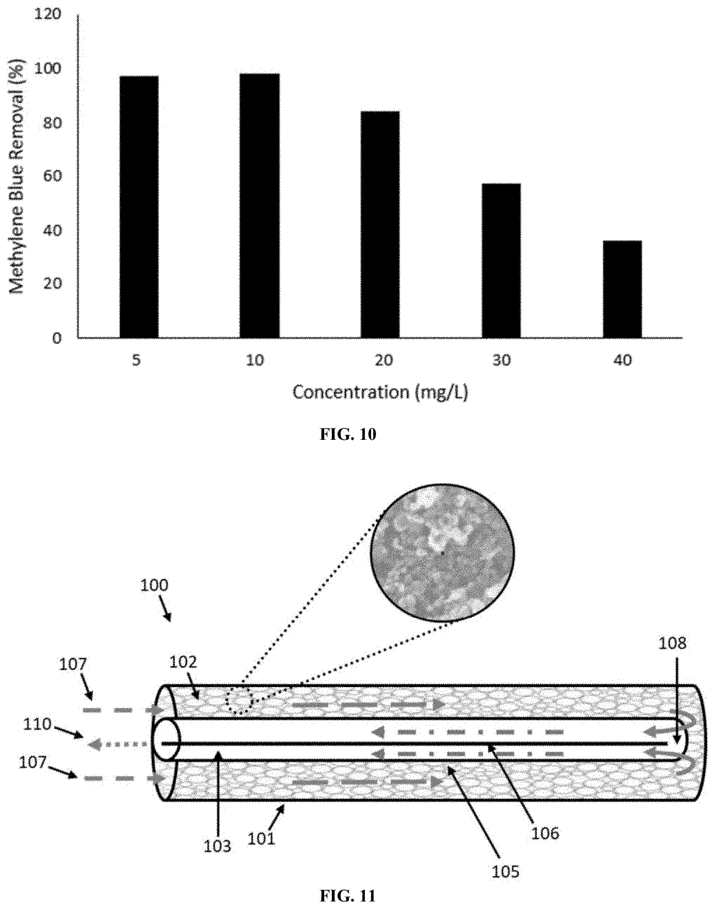

A series of experiments were run on the titanium bonded PP beads of Example 8 using methylene blue as an organic contaminant surrogate. The experiments were run in a column reactor. A series of DWK Life Sciences Kimble™ Kontes™ FlexColumn™ Economy Columns were utilized for the reaction experiments. General specifications of the columns were 15 mm diameter and 200 mm length with a column capacity of 35 mL. Columns were oriented so 20 μm pore size filter discs were at the effluent end, which prevented any media from exiting the system. Column bodies were fabricated from 33 expansion borosilicate glass that had a low-potassium content to yield high UV transmission. A total of four columns were set up in series with three-way stopcock valves on both ends, which acted as sampling ports. Savio Skimmer UV lights (57-Watt lamps) from Aqua Ultraviolet were placed on either side of the column. High-density polyethylene tubing was used to connect the columns. A 100 mL polypropylene syringe was filled with a solution of methylene blue and attached to a NE-300 Just Infusion Syringe Pump. The syringe pumps were set to pump 25 ml/hr, equaling to 40 minutes of contact time. FIG. 10 shows results of methylene blue removal by the photocatalytic bead column at five different initial methylene blue concentrations (5, 10, 20, 30, and 40 mg/L). At 5 and 10 mg/L, over 95% of methylene blue was removed. The data presented in FIG. 10 validated the theory that the photocatalytic PP beads had the ability to degrade organic contaminants at high concentrations.

Methylene blue was selected as it is a common surrogate for organic compounds. Methylene blue does not itself degrade under photolysis, but rather requires the formation of free hydroxyl radicals to initiate degradation. The same is true of indigo carmine and PFOS, which require high basicity coupled with reductive methods or other combinations of technologies.

Examples 10-12 demonstrated design of an example water treatment device including example photocatalytic compositions and its use for treating example organic compounds.

### Example 10

This example presents the design of an example water treatment device including a composition for treating organic compounds.

An example water treatment device was created (100) as shown in FIG. 11. The device (100) included a 6-inch diameter, 26-inch length pipe (101). Within the pipe were two zones, a nucleophilic zone (102) abutting the interior walls of the pipe (101), and a free-radical generation zone (103). The pipe (101) was circumferentially lined with a mixture of calcium silicates (C₂S and C S), calcium silicate hydrate (3CaO.2SiO₂.3H₂O), and calcium hydroxide (Ca[OH]₂) seeded with titanium oxide (P25) to form the nucleophilic zone (102). The pipe (101) and the nucleophilic zone (102) together defined a tube shape wherein the interior of the tube was the free radical generation zone (103). The interior of the nucleophilic zone (102) was lined by titanium-grafted sleeve (105), which encased the free radical generation zone (103) and housed a centrally fixed activation energy source (i.e. a UV lamp, 106). The titanium-grafted sleeve (105) was prepared by grafting maleic anhydride to polypropylene sheets and binding to titanium oxide consistent with the process described in Example 7.

The device (100) was configured such that an influent flow (107) of contaminated water first entered the nucleophilic zone (102) such that the contaminated water passed through the CBM doped with titanium oxide. At mid-column (108), the water flowed out of the nucleophilic zone (102) and into the free-radical generation zone (103) containing the UV lamp (106) within the titanium-grafted sleeve (105). The flow in the free-radical generation zone (103) then exited the water treatment device (100) as an outlet flow (110).

### Example 11

This example presents the results of water treatment tests using the water treatment device.

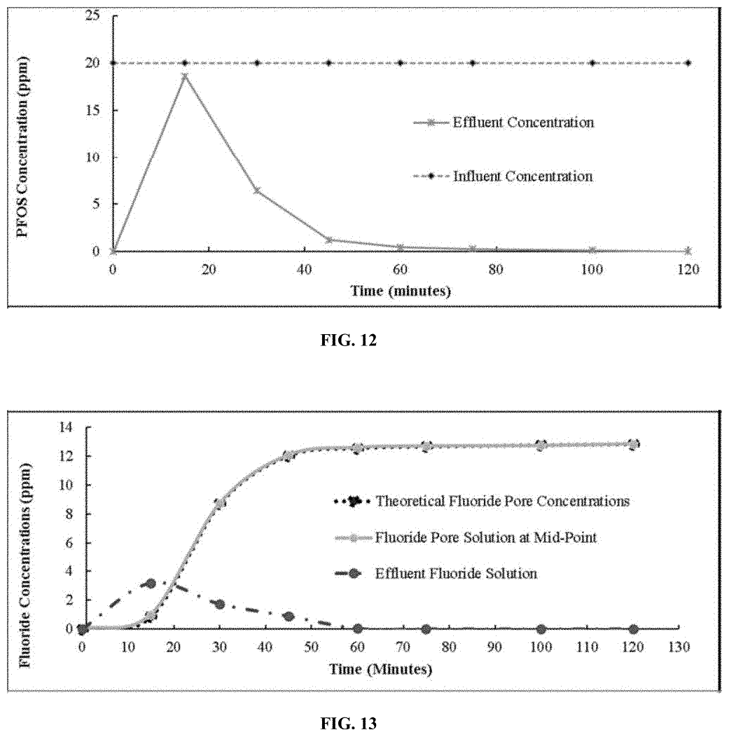

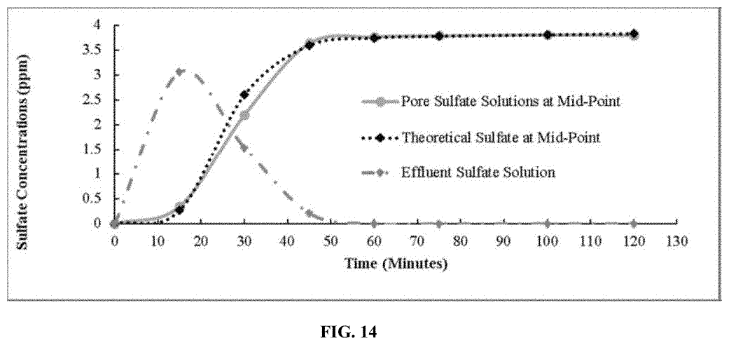

Tests were conducted using water spiked with 1 g/L of perfluorooctanesulfonic acid (PFOS) as example contaminated water. The example contaminated water was passed through the column at 3.5 mL/min. Treated water was collected every 15 minutes at mid-column (108) and at the outlet flow (110). Sampling was conducted with specially designed control systems and an autosampler. Table 1 presents test results quantifying contaminates in the example contaminated water (i.e. the influent flow), in treated water collected from the mid-point, and in treated water collected from the outlet flow. In Table 1, “% Liberated” is the molar mass into the column prior to treatment minus the cumulative molar mass in pore solution divided by the total original molar mass, and “% Mineralized” is the molar mass in solution minus the molar mass in the effluent divided by the total molar mass in solution. FIG. 12 shows PFOS effluent concentration over time relative to influent. Each aliquot represents an average concentration in the aliquot. FIG. 13 shows fluoride concentrations over time at the output flow and mid-point. FIG. 14 shows sulfate concentration over time at the output flow and mid-point.

TABLE 1
Mass balance of contaminated and treated water

| Mass balance (in moles) | | | |
|---|---|---|---|
| of contaminate in: | F⁻ | SO₄²⁻ | PFOS |
| Contaminated water at | 0.4675 | 0.00264 | 12.8083 |
| influent flow | | | |
| Treated water at mid-point | 0.01521 | 0.00445 | 0.82254 |
| Treated water at output flow | 0.00116 | 0.00018 | 0.20256 |
| % Liberated | 96.7 | 92.9 | 98.5 |
| % Mineralized w/in Column | 92.4 | 95.8 | 98.5 |

### Example 12

This example presents SEM evidence of fluorite precipitation due to PFOS degradation.

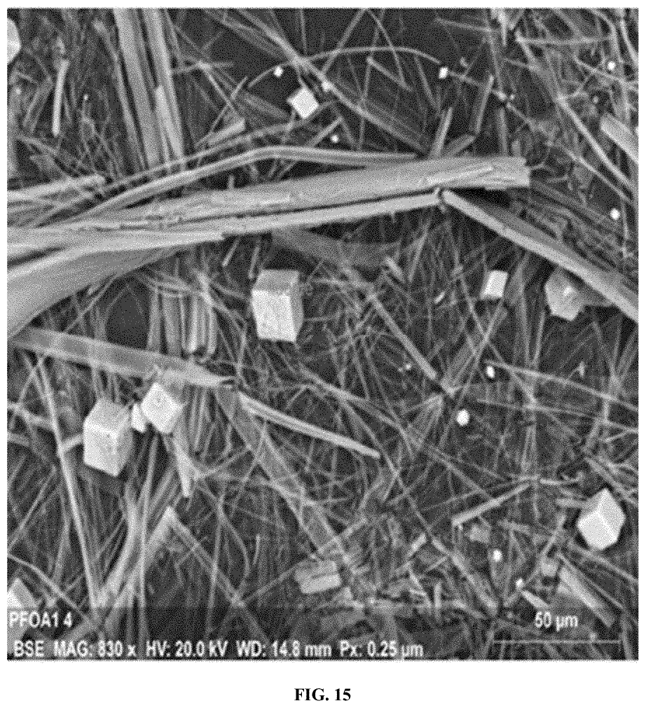

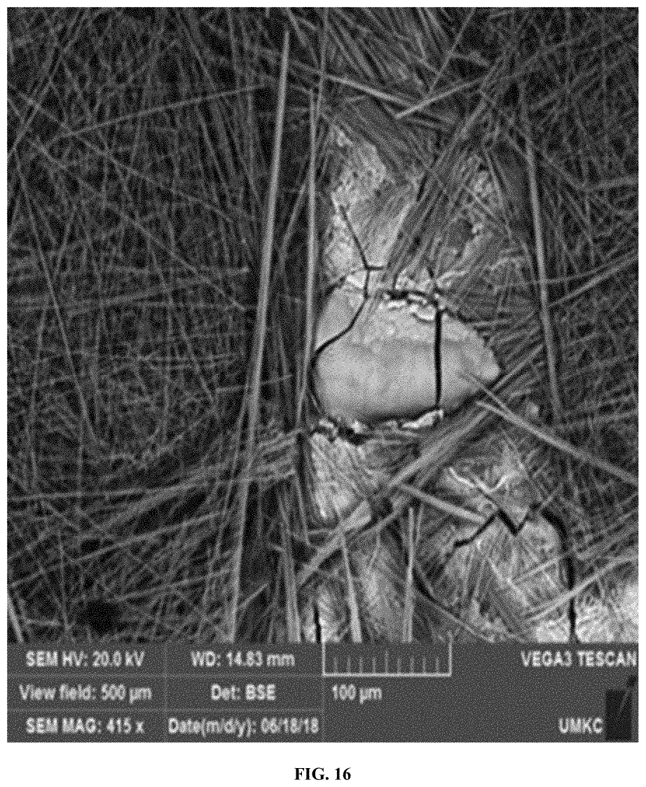

Solutions were extracted from the mid-point at successive time intervals and precipitated onto carbon tape for further inspection by scanning electron microscopy. FIG. 15 shows SEM images before 15 minutes, and FIG. 16 shows SEM images at about 15 minutes. Before 15 minutes, small fluorite minerals were formed with a scale of 50 μm (A). PFOS fibrous precipitates and intermediary byproducts were seen as a needle-like mesh surrounding the fluorite crystals. The fluorite minerals increased in size over time to a scale of 100 μm at approximately 15 minutes, and the precipitated PFOS becomes wider and shorter. This indicated degradation over time of the PFOS molecules, resulting in free fluorite deposition in mineral form.

In sum, catalytic destruction of PFOS was initiated and sustained with self-reinforcing production of hydroxyl radicals and persistent high basicity (nucleophilic attack). Optimized decomposition of reagent grade solutions occurred at approximately 1.06 hours of contact.

When introducing elements of the present disclosure or the preferred embodiments(s) thereof, the articles “a”, “an”, “the” and “said” are intended to mean that there are one or more of the elements. The terms “comprising”, “including” and “having” are intended to be inclusive and mean that there may be additional elements other than the listed elements.

In view of the above, it will be seen that the several objects of the disclosure are achieved and other advantageous results attained.

As various changes could be made in the above methods, processes, and compositions without departing from the scope of the disclosure, it is intended that all matter contained in the above description and shown in the accompanying drawings shall be interpreted as illustrative and not in a limiting sense. The features of the various embodiments may be combined and are not to be considered mutually exclusive alternatives.

What is claimed is:

1. A composition for degrading organic compounds comprising:
a support comprising one or more of a polyolefin and a compound comprising silicon;
an acid anhydride of the structure: 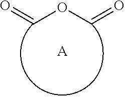
grafted to the polyolefin and/or the compound comprising silicon; and
one or more metal oxides bound with the acid anhydride;
wherein A is a cycloalkyl, heterocycloalkyl, or fused ring system comprising at least one unconjugated -ene group.

2. The composition of claim 1, wherein the support comprises a polyolefin.

3. The composition of claim 1, wherein the support comprises polyethylene or polypropylene.

4. The composition of claim 1, wherein the support comprises a compound comprising silicon.

5. The composition of claim 1, wherein the support is a bead.

6. The composition of claim 1, wherein A is a cycloalkyl or a fused ring system that comprises 4-10 carbons.

7. The composition of claim 1, wherein the acid anhydride is tetrahydrophthalic anhydride or maleic anhydride.

8. The composition of claim 1, wherein the one or more metal oxides comprise titanium, bismuth, or a combination thereof.

9. The composition of claim 1, wherein the one or more metal oxides comprise TiO, TiO₂, Ti₂O₃, Ti₃O, Ti₃O, Ti₄O₇, Ti₅O₉, TiₙO₂ₙ₋₁ where n ranges from 3 to 10, BiOCOOH, Bi₂WO₆, (BiO)₂CO₃, BiVO₄, BiPO₄, Bi₂O₃, BiOCl, or combinations thereof.

10. The composition of claim 1, wherein the one or more metal oxides comprise titanium.

11. The composition of claim 10, wherein the acid anhydride is maleic anhydride, the support comprises a compound comprising silicon, and the composition comprises the structure

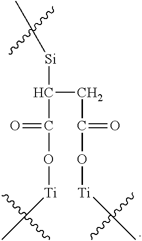

12. The composition of claim 1, wherein the composition is capable of generating aqueous electrons following irradiation.

13. The composition of claim 1, wherein the composition is capable of degrading organic compounds following irradiation.

14. A method for degrading one or more organic compounds in a fluid comprising:
adding into the fluid a composition for degrading organic compounds comprising:
a support comprising one or more of a polyolefin and a compound comprising silicon;
an acid anhydride of the structure 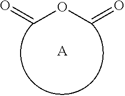
grafted to the polyolefin and/or the compound comprising silicon; and
one or more metal oxides bound with the acid anhydride;
wherein A is a cycloalkyl, heterocycloalkyl, or fused ring system comprising at least one unconjugated -ene group; and
irradiating the composition for degrading organic compounds with electromagnetic radiation.

15. The method of claim 14, wherein the electromagnetic radiation is ultraviolet radiation.

16. The method of claim 14, wherein the organic compound is a perfluoroalkyl substance or polyfluoroalkyl substance.

17. A process for preparing a composition for degrading organic compounds, the process comprising:
heating one or more of a polyolefin and a compound comprising silicon with an acid anhydride of the structure: 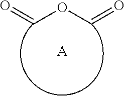
wherein A is a cycloalkyl, heterocycloalkyl, or fused ring system comprising at least one unconjugated -ene group;
forming a support comprising the polyolefin and/or the compound comprising silicon; and
binding the acid anhydride to one or more metal oxides.

18. The process of claim 17, wherein the acid anhydride is bound to the metal oxide before heating the polyolefin and/or the compound comprising silicon with the acid anhydride.

19. The process of claim 17, wherein the process comprises heating the polyolefin and the polyolefin is polyethylene or polypropylene.

20. The process of claim 17, wherein the process comprises heating the compound comprising silicon
